(19) United States
(12) Patent Application Publication
(10) Pub. No.: US 2010/0059726 A1
(43) Pub. Date: Mar. 11, 2010

(54) MULTICOLOR-ENCODED COLLOIDAL PARTICLES COATED WITH METAL NANOPARTICLES MIXTURE HAVING COLORS IN THE VISIBLE REGION AND METHOD FOR PREPARING THE SAME

(75) Inventors: Bong Hyun Jung, Daejeon (KR); Yong Taik Lim, Daejeon (KR); Jin Kyeong Kim, Daejeon (KR)

Correspondence Address: MOORE & VAN ALLEN PLLC, P.O. BOX 13706, Research Triangle Park, NC, 27709, US

(73) Assignee: Korea Research Institute of Bioscience and Biotechnology, Daejeon (KR)

(21) Appl. No.: 11/915,519

(22) PCT Filed: Feb. 13, 2006
(86) PCT No.: PCT/KR2006/000494

§ 371 Date: Aug. 8, 2008

(30) Foreign Application Priority Data
May 23, 2005 (KR) 1020050043102

(51) Int. Cl. G02B 1/00

(52) U.S. Cl. 252/582; 977/773

(57) ABSTRACT

The present invention relates to multicolor colloidal particles coated with a metal nanoparticle mixture having colors in the visible region and a method for preparing the same. In particular, relates to a metal nanoparticle mixture in which two or more nanoparticles selected from the group consisting of metal nanoparticles exhibiting red color; metal nanoparticles exhibiting yellow color; and metal nanoparticles exhibiting blue color, are mixed in various compositional ratio, multicolor colloidal particles in which polymer or mineral colloidal particles are coated with the metal nanoparticle mixture, and a method for preparing the same. According to the present invention, all colors that are in the visible region can be developed by suitably mixing metal nanoparticles exhibiting three colors, and multicolor colloidal particles can be prepared by coating polymer or mineral colloidal particles with a metal nanoparticle mixture exhibiting various colors.

### TECHNICAL FIELD

The present invention relates to colloidal particles coated with a metal nanoparticle mixture exhibiting colors in the visible region and a method for preparing the same. In particular, the present invention relates to a metal nanoparticle mixture exhibiting color in the visible region in which two or more nanoparticles selected from the group consisting of metal nanoparticles exhibiting red color; metal nanoparticles exhibiting yellow color; and metal nanoparticles exhibiting blue color, are mixed in various compositional ratios, multicolor colloidal particles in which polymer or mineral colloidal particles are coated with the metal nanoparticle mixture, and a method for preparing the same.

### BACKGROUND ART

Nanoparticles consisted of gold and silver have a phenomenon (Surface Plasmon Resonance Effect) that strongly absorbs or scatters a light at a certain wavelength. Because of the effect, metal nanoparticles have been used as pigments for developing various colors. In comparison with organic dyes, metal nanoparticles have excellent absorbing and scattering characteristics as well as optical stabilities. Additionally, the surface plasmon resonance frequency may be controlled by changing their size, shape, structure and the like, to prepare metal nanoparticles exhibiting various colors.

By using the characteristics of metal nanoparticles described above, researches on biosensors that can sense bio-substances for example, genes (DNA) or proteins have been actively conducted since color changes can be observed readily by the naked eye without special optical equipments or tools.

Although metal nanoparticles are used in the form of their colloidal solution per se, they can be used as a tool of surface enhanced Raman scattering (SERS) effect after a substrate is coated with them, or as various biological and chemical sensors by arranging them in the form of uniform arrays or coating a surface of spherical colloidal particles with them.

Because of these reasons, many researches to prepare nanoparticles exhibiting various colors are actively being conducted until recently by controlling the sizes and shapes of metal nanoparticles. US Patent Publication 2005/0287680 discloses a method for detecting biological samples using metal nanoparticles exhibiting various colors according to sizes.

However, to prepare colloidal particles coated with metal nanoparticle mixture exhibiting various colors using a conventional system, various types of particles whose sizes and shapes are different from each other should be prepared separately at different reaction conditions, and it is also difficult to develop various colors reproducibly.

Meanwhile, Korean Patent Publication 10-2005-0030398 discloses a make-up cosmetic composition containing gold silica nanoparticles that can effectively inhibit shininess due to sebum secretion. However, the used gold nanoparticles are limited to the particles of 20-50 nm exhibiting red color, and it is difficult to exhibit various colors. Additionally, US Patent Publication 2004/0058488 discloses a method for detecting chemical, biological and biochemical samples using colloidal particles having various chemical functional groups on their surface as a sensor. However, since the method uses optical tweezers to detect samples, it is difficult to detect sample readily.

The present applicants has been carried out many studies to solve the problems as described above, and as a result, found that it is possible to prepare multicolor colloidal particles exhibiting various colors by combining three types of metal nanoparticles that exhibit red, yellow and blue colors in a suitable compositional ratio, thereby completing the present invention.

### SUMMARY OF INVENTION

Accordingly, the present invention has been made to solve the above-mentioned problems occurring in the prior art, and it is an object of the present invention to provide a metal nanoparticle mixture that can develop various colors in the visible region by combining two or more metal nanoparticles.

It is another object of the present invention to provide multicolor metal colloidal particles in which the metal nanoparticle mixture is coated on a surface of colloidal particles, such as polymers or inorganic substance and a method for preparing the same.

To accomplish the above object, the present invention provides a metal nanoparticle mixture exhibiting colors in the visible region, in which two or more nanoparticles selected from the group consisting of metal nanoparticles exhibiting red color; metal nanoparticles exhibiting yellow color; and metal nanoparticles exhibiting blue color, are mixed in various compositional ratios.

In the present invention, the metal nanoparticles are preferably in the form of nanospheres, nanorods, nanoshells, nanocubes or nanoprisms, but it is not limited thereto.

In the present invention, the metal nanoparticles exhibiting red color are spherical gold nanoparticles, the metal nanoparticles exhibiting yellow color are silver nanoparticles, and the metal nanoparticles exhibiting blue color are gold nanorods, nanoshells, nanocubes or nanoprisms.

The metal nanoparticles exhibiting red color are preferably prepared by following steps:
(a) refluxing a solution of HAuCl₄ at about 100° C.;
(b) adding a reducing agent to the refluxed solution, followed by heating and reacting the mixed solution; and
(c) cooling the reaction solution to room temperature and filtering it.

However, it is not limited thereto.

Additionally, the metal nanoparticles exhibiting yellow color are preferably prepared by following steps:
(a) mixing AgNO₃, PVP (polyvinylpyrrolidone) and EG (ethylene glycol), and stirring the resulting mixture;
(b) refluxing the mixture at about 120° C.; and
(c) cooling the refluxed reaction solution to room temperature and filtering it.

However, it is not limited thereto.

Also, the metal nanoparticles exhibiting blue color are preferably prepared by following steps:
(a) adding a reducing agent to the silver nanoparticles exhibiting yellow color prepared as described above, and refluxing the resulting mixture at about 100° C.;
(b) allowing to react while adding a solution of HAuCl₄ to the refluxed reaction solution; and
(c) cooling the reaction solution to room temperature and filtering it. However, it is not limited thereto.

Further, the present invention provides multicolor metal colloidal particles in which the metal nanoparticle mixture is coated on the surface of colloidal particles, such as polymers or inorganic substance.

Also, the present invention provides a method for preparing multicolor metal colloidal particles in which the metal nanoparticle mixture exhibiting colors in the visible region is coated on the surface of colloidal particles, the method comprising the following steps:
(a) mixing the metal nanoparticle mixture with polymer or mineral colloidal particles and allowing them to react; and
(b) obtaining multicolor metal colloidal particles coated with the metal nanoparticles from the reaction product.

In the present invention, the surfaces of the polymer or mineral colloidal particles are preferably treated with a functional group selected from the group consisting of amine, thiol, hydroxyl, carboxyl and aminodextrin groups. Additionally, the polymer or mineral colloidal particles are preferably selected from the group consisting of polystyrene, polystyrene-methacrylic acid, polystyrene-divinylbezene, polymethylmethacrylate, polyphenylene oxide, polyurethane, dendrimer, silica, silicon dioxide, TiO₂ and glass bead.

In the method of preparing multicolor metal colloidal particles according to the present invention, the reaction of step (a) is preferably carried out under the condition of about pH 6.8.

Other features and embodiments of the present invention will be more fully apparent from the following detailed description and appended claims.

### BRIEF DESCRIPTION OF DRAWINGS

FIG. 1 is a schematic view representing a process of preparing multicolor colloidal particles by coating a metal nanoparticle mixture, in which metal nanoparticles exhibiting three colors (red, yellow and blue colors) are mixed in a certain compositional ratio, on polymer or mineral particles.

FIG. 2 shows multicolor metal nanoparticle mixture obtained by mixing metal nanoparticles exhibiting three colors (red, yellow and blue colors) in a certain compositional ratio.

FIG. 3 shows an absorption spectrum of a metal nanoparticle mixture in which gold nanoparticles exhibiting red color and silver nanoparticles exhibiting yellow color are mixed in a certain compositional ratio, and a metal nanoparticle mixture exhibiting various colors.

FIG. 4 shows an absorption spectrum of a metal nanoparticle mixture in which silver nanoparticles exhibiting yellow color and gold nanoshell particles exhibiting blue color are mixed in a certain compositional ratio, and a metal nanoparticle mixture exhibiting various colors.

FIG. 5 shows an absorption spectrum of a metal nanoparticle mixture in which gold nanoparticles exhibiting red color and gold nanoshell particles exhibiting blue color are mixed in a certain compositional ratio, and a metal nanoparticle mixture exhibiting various colors.

FIG. 6 shows tubes containing colloidal particles prepared by coating metal nanoparticle mixtures corresponding to seven rainbow colors on spherical polystyrene microparticles, respectively.

FIG. 7 is transmission electron microscopy (TEM) images of the surfaces of colloidal particles prepared by coating spherical gold nanoparticles on polymer particles in four kinds of pH solutions (pH 4.0, pH 6.0, pH 6.8 and pH 8.5).

FIG. 8 shows colors of colloidal particles prepared by coating spherical gold nanoparticles on polymer particles in four kinds of pH solutions (pH 4.0, pH 6.0, pH 6.8 and pH 8.5).

FIG. 9 is scanning electron microscopy (SEM) images of the surfaces of colloidal particles obtained by coating the metal nanoparticle mixture according to the present invention on the surfaces of polymer and silica particles.

FIG. 10 is TEM images of metal nanoparticles according to the present invention, coated on the surfaces of polymer particles. To distinguish each characteristic structure, red spherical gold nanoparticles, yellow spherical silver nanoparticles, a mixture of green spherical silver nanoparticles and nanoshell type of gold nanoparticles and blue nanoshell type of gold nanoparticles are selected representatively. In FIG. 10, the photographs of right row are 5× enlarged photographs of left row.

FIG. 11 shows the result of Energy Dispersive X-Spectroscopy (EDX) analysis on polymer microparticles coated with spherical silver nanoparticles.

FIG. 12 is EDX analysis result of polymer microparticles coated with spherical silver nanoparticles and nanoshell type of gold nanoparticles.

FIG. 13 is EDX analysis result of polymer microparticles coated with nanoshell type of gold nanoparticles.

### DETAILED DESCRIPTION OF THE INVENTION AND PREFERRED EMBODIMENTS

The present invention relates to a metal nanoparticle mixture exhibiting colors in the visible region in which two or more nanoparticles selected from the group consisting of metal nanoparticles exhibiting red color; metal nanoparticles exhibiting yellow color; and metal nanoparticles exhibiting blue color, are mixed in various compositional ratios, multicolor colloidal particles that polymer or mineral colloidal particles are coated with the metal nanoparticle mixture, and a method for preparing the same.

As used herein, “mixing in various compositional ratios” means that metal nanoparticles exhibiting two respective colors are mixed in compositional ratio of 0.1:9.9 to 9.9:0.1 as described in following examples, thereby developing various colors that are in between two colors above. Accordingly, colors corresponding to spectrum of red color-flame color-yellow color can be developed by mixing nanoparticles exhibiting red color with nanoparticles exhibiting yellow color; colors corresponding to spectrum of yellow color-green color-blue color can be developed by mixing nanoparticles exhibiting yellow color with nanoparticles exhibiting blue color; and colors corresponding to spectrum of blue color-navy blue color-violet color-red color can be developed by mixing nanoparticles exhibiting blue color with nanoparticles exhibiting red color.

To develop various colors, nanoparticles exhibiting red color, nanoparticles exhibiting yellow color and nanoparticles exhibiting blue color are selected as primary constituting materials. Red color is developed by preparing spherical gold nanoparticles, and yellow color is developed by preparing spherical silver nanoparticles. Blue color is developed by preparing nanoshell type of gold particles, in which hollow type of gold nanoparticles exhibiting blue color was prepared using silver nanoparticles exhibiting yellow color to use.

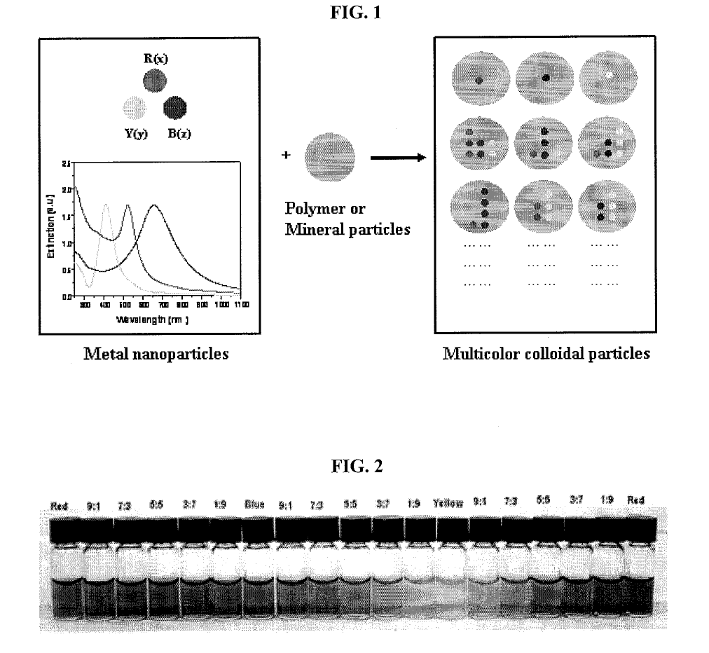

Metal nanoparticles having various types and sizes including nanorods, nanoshells, nanocubes, nanoprisms and the like in addition to nanospheres, can be used as particles exhibiting red color, yellow color and blue color. In the case where these metal nanoparticles exhibiting red color, yellow color and blue color are mixed in a suitable compositional ratio, metal nanoparticle solution exhibiting various colors caused by combination of red color, yellow color and blue color can be prepared. Additionally, spherical microparticles exhibiting various colors can be prepared by coating microparticles with the metal nanoparticle solution (FIG. 1).

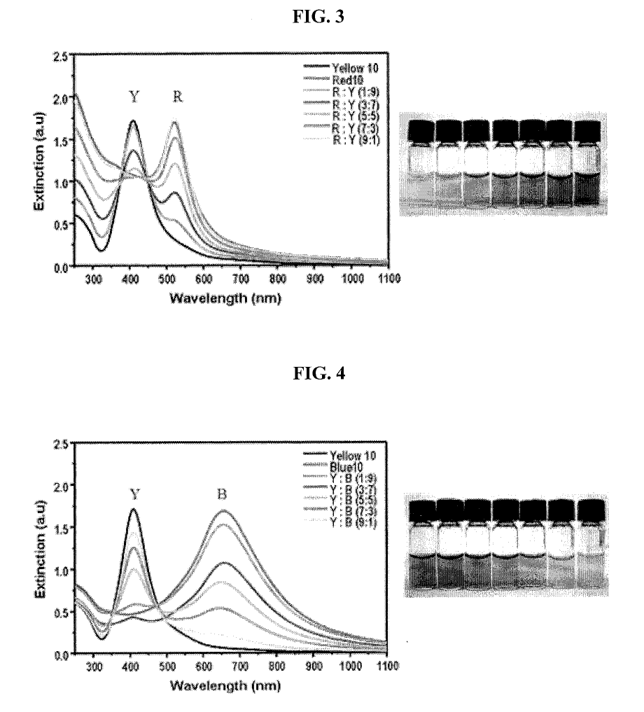

In the case where three metal nanoparticles according to the present invention are combined in a certain compositional ratio, all colors in the visible region can be exhibited (FIG. 2). Namely, in the case where spherical gold nanoparticles exhibiting red color are combined with spherical silver nanoparticles exhibiting yellow color in a certain compositional ratio, various colors that are in between red color and yellow color can be developed (FIG. 3). Also, in the case where spherical silver nanoparticles exhibiting yellow color are combined with nanoshell type of gold nanoparticles exhibiting blue color in a certain compositional ratio, various colors that are in between yellow color and blue color can be developed (FIG. 4). Additionally, in the case where spherical gold nanoparticles exhibiting red color are combined with nanoshell type of gold nanoparticles exhibiting blue color in a certain compositional ratio, various colors that are in between red color and blue color can be developed (FIG. 5). As a result, all colors that are in the visible region can be developed by combining the three metal nanoparticles according to the present invention.

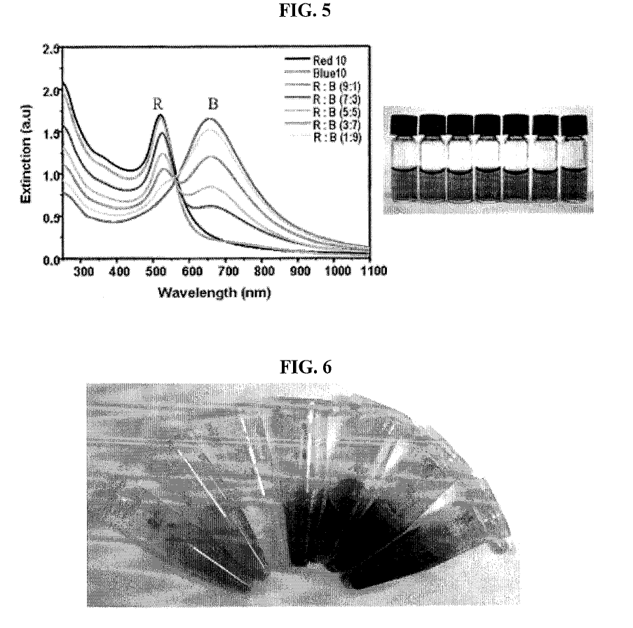

Further, colloidal particles exhibiting various colors can be prepared by coating polymer or metal particles with the metal nanoparticle mixture prepared as described above. For example, as shown in FIG. 6, colloidal particles exhibiting rainbow color can be prepared by coating spherical polystyrene microparticles with metal nanoparticle mixture exhibiting seven colors corresponding to rainbow color.

In the present invention, polystyrene having amine group substituted for its surface is used as microparticles, but it is not limited thereto. For example, polymer particles such as polystyrene having various functional groups including amine group, thiol group, hydroxyl group, carboxyl group, aminodextrin group and the like, polystyrene-methacrylic acid, polystyrene-divinylbezene, polymethylmethacrylate, polyphenylene oxide, polyurethane, dendrimer, silica, silicon dioxide, TiO₂, glass bead and the like, can be used as microparticles.

The size of the particles used in the present invention is not limited to μm range, and can be extended to inorganic nanoparticles or polymer particles having a size of 100 nm˜1 mm range.

### EXAMPLES

The following specific examples are intended to be illustrative of the invention and should not be construed as limiting the scope of the invention as defined by appended claims.

In the following examples, the same sign means the same element. Furthermore, since various elements and regions in the drawing is shown schematically, it should not be interpreted to be limited by the relative size or interval.

Particularly, a certain combination ratio of nanoparticles exhibiting three colors is exemplified in the following examples, it is obvious to a skilled person in the art that the combination rate is not limited thereto.

### Example 1

### Preparation of Nanoparticle Mixture Exhibiting Various Colors

### <1-1> Preparation of Metal Nanoparticles Exhibiting Three Colors

To prepare metal nanoparticles exhibiting red color, yellow color and blue color that is three primary colors, spherical gold nanoparticles and silver nanoparticles were prepared first.

To prepare spherical gold nanoparticles exhibiting red color, 500 ml of HAuCl₄ (1 mM) was added to round bottom flask to heat at 100° C. under reflux. 50 ml of trisodium citrate (38.8 mM), reducing agent was added to the resulting solution. After confirming that the color of the reaction solution was changed from yellow color to dark red color, the reaction liquid was further heated for 15 min, cooled to room temperature, and filtered with 0.2 μm microfilter.

To prepare silver nanoparticles exhibiting yellow color, AgNO₃ (0.04 g), PVP (polyvinylpyrrolidone) (1 g) and 7.5 ml of EG (ethylene glycol) were mixed, and stirred vigorously. The mixture was refluxed at 120° C. for 4 hrs, cooled to room temperature, and filtered with 0.2 μm microfilter.

To prepare gold nanoshell type of particles exhibiting blue color, silver nanoparticles exhibiting yellow color prepared as described above were used. 1 ml of the silver nanoparticles exhibiting yellow color was diluted with 50 ml of trisodium citrate (0.4 mM aqueous solution), and then refluxed at 100° C. for 10 min. The resulting solution was stirred vigorously while injecting 2 ml of HAuCl₄ (10 mM) at 45 ml/h using microsyringe pump, and then, allowed to react further for 20 min, cooled to room temperature, and filtered with 0.2 μm microfilter.

### <1-2> Preparation of Metal Nanoparticle Mixture Exhibiting Various Colors

Various colors were developed by mixing metal nanoparticles exhibiting red color, yellow color and blue color, i.e. three primary colors prepared in the example <1-1> in a certain compositional ratio. In this case, OD (optical density) of the used metal nanoparticles was adjusted to 2.8 using UV-vis-spectrometry.

First, spherical gold nanoparticles exhibiting red color and silver nanoparticles exhibiting yellow color were mixed in volume ratios of 9:1, 7:3, 5:5, 3:7, 1:9, respectively. As a result, a color corresponding to a spectrum spanning red color-flame color-yellow color in the visible region was developed (FIG. 2 and FIG. 3)

Silver nanoparticles exhibiting yellow color and gold nanoshell particles exhibiting blue color were mixed in volume ratios of 9:1, 7:3, 5:5, 3:7, 1:9, respectively. As a result, a color corresponding to a spectrum spanning yellow color-green color-blue color was developed (FIG. 2 and FIG. 4).

Gold nanoshell particles exhibiting blue color and gold nanoparticles exhibiting red color were mixed in volume ratios of 9:1, 7:3, 5:5, 3:7, 1:9, respectively. As a result, a color corresponding to a spectrum spanning blue color-navy blue color-violet color-red color was developed (FIG. 2 and FIG. 5).

### Example 2

### Preparation of Colloidal Particles Coated with Metal Nanoparticle Mixture Exhibiting Various Colors

After selecting seven metal nanoparticle mixtures exhibiting seven colors corresponding to rainbow color from the metal nanoparticle mixture prepared in example <1-2>, the selected respective metal nanoparticle mixtures were coated on polystyrene beads whose surfaces were treated with amine group. For the coating process, polystyrene beads (3.18 μm, Bangs laboratories, 1 wt % aqueous solution) was diluted (5×), and then 0.5 ml of the diluted solution was mixed with 4 ml of respective metal nanoparticle mixture exhibiting seven colors corresponding to rainbow color, which is adjusted to OD of 2.8.

The polystyrene beads were coated with the resulting mixtures at room temperature for one day. It was confirmed that the coated polymer particles were precipitated after 4 hrs at room temperature, and could be separated readily by centrifuging them at 1000 rpm. As a result, as shown in FIG. 6, colloidal particles exhibiting seven colors could be prepared.

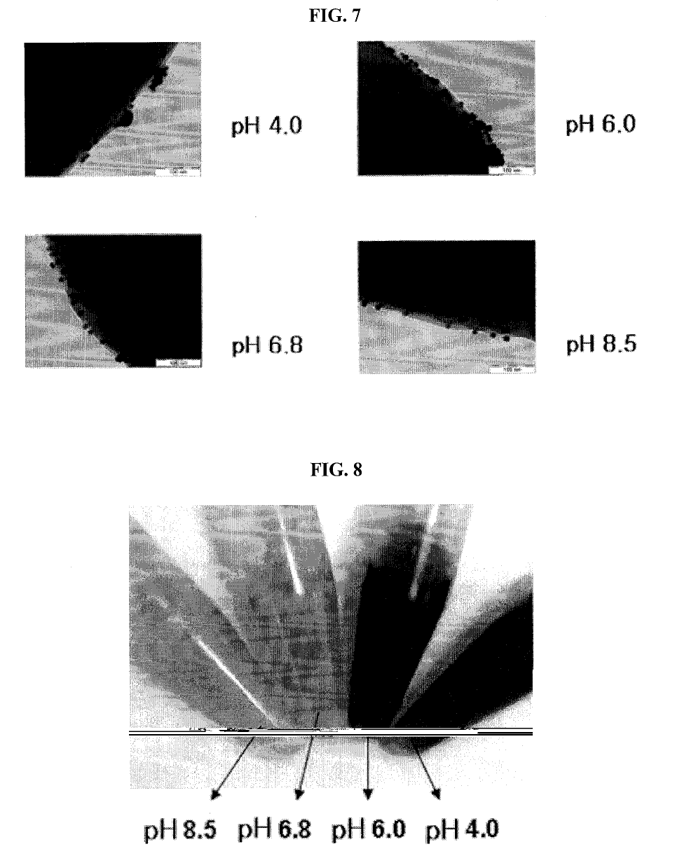

To find optimum pH reaction conditions for coating a metal nanoparticle mixture on the surfaces of colloidal particles, metal colloidal particles were reacted with the surfaces of microparticles under various pH condition. FIG. 7 is a photograph of TEM (transmission electron microscopy) showing the surfaces of colloidal particles prepared by coating spherical gold nanoparticles on polymer particles in four different pH solutions (pH 4.0, pH 6.0, pH 6.8 and pH 8.5). FIG. 8 shows the colors of colloidal particles prepared by coating spherical gold nanoparticles on polymer particles in four different pH solutions as described above.

As shown in FIG. 7 and FIG. 8, as a result of coating respective spherical gold nanoparticles exhibiting red color on the surfaces of polystyrene nanoparticles in reaction solutions of pH 4, pH 6, pH 6.8 and pH 8.5, in the case where pH was 6.8 or less, spherical metal nanoparticles were coated on the surfaces of polystyrene beads in the form of cluster and in the case where pH was 6.8 or more, respective spherical metal nanoparticles were distributed uniformly on the surfaces of polystyrene beads. So, it could be observed that a color of the solution was changed from red color to violet color and then navy blue color according to the degree of clustering. Based on the experiment results, all reactions were carried out at pH 6.8.

### Example 3

### Identification of Multicolor Colloidal Particles

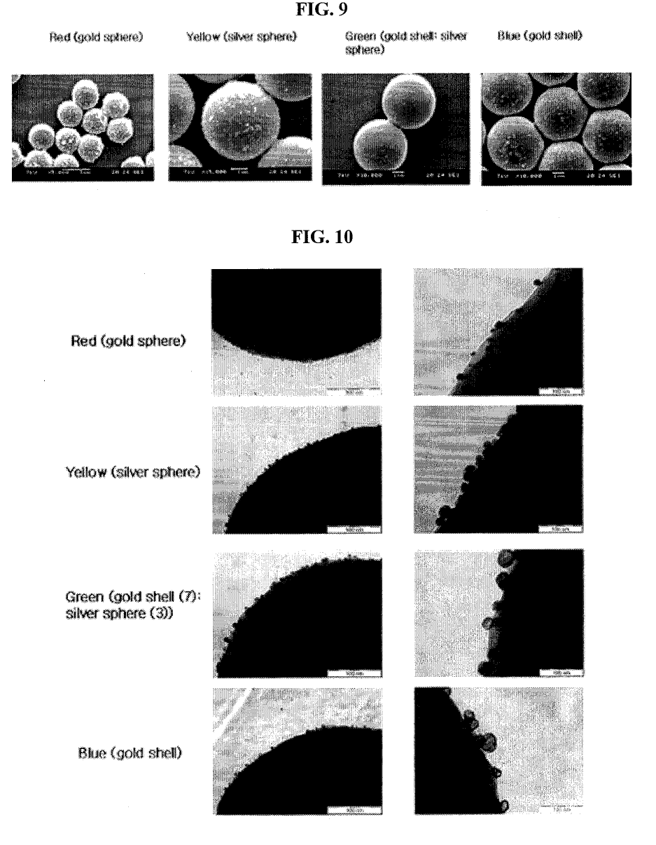

Colloidal particles coated with metal nanoparticle mixture exhibiting various colors prepared in example 2 were identified using SEM (scanning electron microscopy) and TEM (transmission electron microscopy). Namely, after separating polymer particles coated with metal nanoparticles prepared in example 2, their surface structures were analyzed using SEM (FIG. 9) and structures of metal nanoparticles coated on the surfaces of polymer particles were examined thoroughly using TEM (FIG. 10).

FIG. 9 is a photograph of scanning electron microscopy (SEM) showing the surfaces of colloidal particles obtained by coating the metal nanoparticle mixture on the surfaces of polymer and silica particles. To distinguish each characteristic structures readily, spherical gold nanoparticles exhibiting red color, spherical silver nanoparticles exhibiting yellow color, a mixture of spherical silver nanoparticles exhibiting green color and nanoshell type of gold nanoparticles, and nanoshell type of gold nanoparticles were selected representatively to show.

FIG. 10 is TEM images for identifying structures of metal nanoparticles coated on surfaces of polymer particles. To distinguish each characteristic structures, red spherical gold nanoparticles, yellow spherical silver nanoparticles, a mixture of green spherical silver nanoparticles and nanoshell type of gold nanoparticles and blue nanoshell type of gold nanoparticles are selected representatively to show. In FIG. 10, the photographs of right row are 5× enlarged photographs of left row.

As shown in FIG. 10, it was observed that spherical silver nanoparticles were coated on the surfaces of the polymer particles in the case of yellow color, and nanoshell type of gold nanoparticles were coated on the surfaces of the polymer particles in the case of blue color, in which they could be distinguished readily from spherical particles as shown in the second image of FIG. 10 due to gold nanoparticles having empty inside.

Meanwhile, in the case of green color, it was readily found that spherical silver nanoparticles and nanoshell type of gold nanoparticles were coated together to exhibit green color, due to their structural difference.

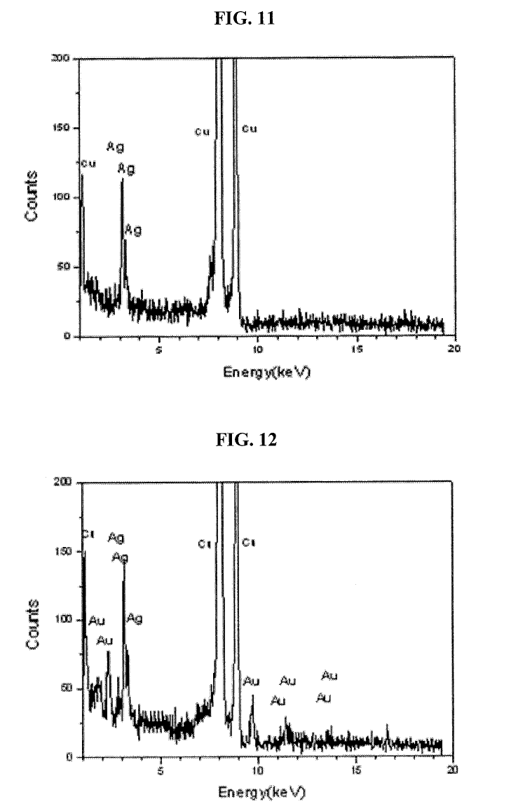

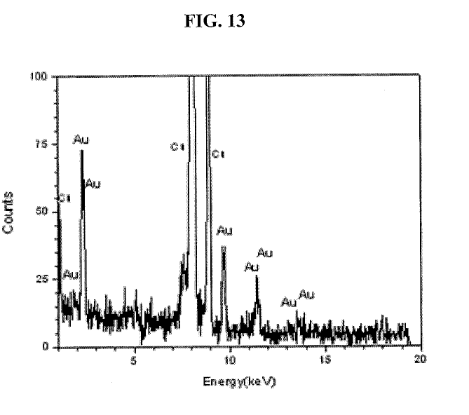

Additionally, components of metal coated on the surface of polymer microparticles were reidentified by EDX (Energy Dispersive X-Spectroscopy) analysis (FIGS. 11 to 13). FIG. 11 is EDX analysis result of polymer microparticles coated with spherical silver nanoparticles, from which the components of silver nanoparticles could be identified. FIG. 12 is EDX analysis result of polymer microparticles coated with spherical silver nanoparticles exhibiting green color and nanoshell type of gold nanoparticles, from which the presence of silver nanoparticles and gold nanoparticles could be identified. Namely, it could be confirmed that spherical particles exhibiting green color have both silver nanoparticles exhibiting yellow color and nanoshell type of gold nanoparticles exhibiting blue color. Also, FIG. 13 is EDX analysis result of polymer microparticles coated with nanoshell type of gold nanoparticles, from which the presence of gold nanoparticles could be identified.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

### INDUSTRIAL APPLICABILITY

As described above in detail, according to the present invention, all colors that are in the visible region can be developed by suitably mixing metal nanoparticles exhibiting three colors, and multicolor colloidal particles exhibiting various colors can be prepared by coating polymer or mineral colloidal particles with metal nanoparticles mixture exhibiting various colors according to the present invention. Colloidal particles exhibiting various colors prepared by coating polymer or mineral particles with metal nanoparticle mixture exhibiting various colors can be used diversely as biosensor, and the like in the biological and medical fields

1. A metal nanoparticle mixture exhibiting colors in the visible region, wherein two or more nanoparticles selected from the group consisting of metal nanoparticles exhibiting red color; metal nanoparticles exhibiting yellow color; and metal nanoparticles exhibiting blue color, are mixed in various compositional ratios.

2. The metal nanoparticle mixture according to claim 1, wherein the metal nanoparticles are in the form selected from the group consisting of nanospheres, nanorods, nanoshells, nanocubes and nanoprisms.

3. The metal nanoparticle mixture according to claim 1, wherein the metal nanoparticles exhibiting red color are spherical gold nanoparticles, the metal nanoparticles exhibiting yellow color are silver nanoparticles, and the metal nanoparticles exhibiting blue color are selected from the group consisting of gold nanorods, gold nanoshells, gold nanocubes and gold nanoprisms.

4. The metal nanoparticle mixture according to claim 1, wherein the metal nanoparticles exhibiting red color are prepared by following steps:
(a) refluxing a solution of HAuCl₄ at about 100° C.;
(b) adding a reducing agent to the refluxed solution, followed by heating and reacting the mixed solution; and
(c) cooling the reaction solution to room temperature and filtering it.

5. The metal nanoparticle mixture according to claim 1, wherein the metal nanoparticles exhibiting yellow color are prepared by following steps:
(a) mixing AgNO₃, PVP (polyvinylpyrrolidone) and EG (ethylene glycol), and stirring the resulting mixture;
(b) refluxing the mixture at about 120° C.; and
(c) cooling the refluxed reaction solution to room temperature and filtering it.

6. The metal nanoparticle mixture according to claim 1, wherein the metal nanoparticles exhibiting blue color are prepared by following steps:
(a) adding a reducing agent to metal nanoparticles exhibiting yellow and refluxing the resulting mixture at about 100° C.;
(b) carrying out the reaction while adding a solution of HAuCl₄ to the refluxed reaction solution; and
(c) cooling the reaction solution to room temperature and filtering it.

7. Multicolor metal colloidal particles, wherein polymer or mineral colloidal particles are coated with the metal nanoparticle mixture of claim 1.

8. The multicolor metal colloidal particles according to claim 7, wherein the surfaces of polymer or mineral colloidal particles are treated with a functional group selected from the group consisting of amine group, thiol group, hydroxyl group, carboxyl group and aminodextrin group.

9. The multicolor metal colloidal particles according to claim 7, wherein the polymer or mineral colloidal particles are selected from the group consisting of polystyrene, polystyrene-methacrylic acid, polystyrene-divinylbezene, polymethylmethacrylate, polyphenylene oxide, polyurethane, dendrimer, silica, silicon dioxide, TiO₂ and glass bead.

10. The multicolor metal colloidal particles according to claim 7, wherein the sizes of the polymer or mineral colloidal particles are 100 nm˜1 mm.

11. A method for preparing multicolor metal colloidal particles, in which the metal nanoparticle mixture exhibiting colors in the visible region is coated on the surfaces of colloidal particles, the method comprising the following steps:
(a) mixing the metal nanoparticle mixture of claim 1 with polymer or mineral colloidal particles and allowing them to react; and
(b) obtaining multicolor metal colloidal particles coated with the metal nanoparticles from the resulting product.

12. The method for preparing multicolor metal colloidal particles according to claim 11, wherein the step (a) is carried out under the condition of about pH 6.8.

13. The method for preparing multicolor metal colloidal particles according to claim 11, wherein the surfaces of polymer or mineral colloidal particles are treated with a functional group selected from the group consisting of amine group, thiol group, hydroxyl group, carboxyl group and aminodextrin group.

14. The method for preparing multicolor metal colloidal particles according to claim 11, wherein the polymer or mineral colloidal particles are selected from the group consisting of polystyrene, polystyrene-methacrylic acid, polystyrene-divinylbezene, polymethyl-methacrylate, polyphenylene oxide, polyurethane, dendrimer, silica, silicon dioxide, TiO₂ and glass bead.

15. The metal nanoparticle mixture according to claim 6, wherein the metal nanoparticles exhibiting yellow color are prepared by following steps:
(a) mixing AgNO₃, PVP (polyvinylpyrrolidone) and EG (ethylene glycol), and stirring the resulting mixture;
(b) refluxing the mixture at about 120° C.; and
(c) cooling the refluxed reaction solution to room temperature and filtering it.
